(19) United States
(12) Patent Application Publication
(10) Pub. No.: US 2022/0114487 A1
(43) Pub. Date: Apr. 14, 2022

(54) SYSTEM AND METHOD FOR PATENT CLUSTERING

(71) Applicant: Erich Lawson Spangenberg, Paris (FR)

(72) Inventor: Erich Lawson Spangenberg, Paris (FR)

(21) Appl. No.: 17/467,137

(22) Filed: Sep. 3, 2021

Related U.S. Application Data
(60) Provisional application No. 63/075,039, filed on Sep. 4, 2020.

(51) Int. Cl. G06N 20/00; G06Q 50/18

(52) U.S. Cl. CPC G06N 20/00; G06Q 50/184

(57) ABSTRACT

The present invention uses an agglomerative hierarchical clustering (“AHC”) method for patent clustering. Agglomerative clustering is the most common type of hierarchical clustering used to group objects in clusters based on their similarity. It's also known as Agglomerative Nesting (“AGNES”). The algorithm starts by treating each object as a singleton cluster. Next, pairs of clusters are successively merged until all clusters have been merged into one big cluster containing all objects. The result is a tree-based representation of the objects, known as a dendrogram. This methodology is used in a broad range of applications. In one embodiment, the present invention uses specific requirements of the data in order to create smart ways of choosing which levels are included and which are excluded.

### PRIORITY CLAIMS

This application claims the benefit of U.S. Provisional Patent Application Ser. No. 63/075,039, filed on Sep. 4, 2020, the contents of which are incorporated herein.

### BACKGROUND OF THE INVENTION

The field of invention is related to the selection of distances for the display of agglomerative hierarchal patent clustering.

### SUMMARY OF THE INVENTION

The present invention uses an agglomerative hierarchical clustering (“AHC”) method for patent clustering. Agglomerative clustering is the most common type of hierarchical clustering used to group objects in clusters based on their similarity. It's also known as Agglomerative Nesting (“AGNES”). The algorithm starts by treating each object as a singleton cluster. Next, pairs of clusters are successively merged, based on a distance criteria, until all clusters have been merged into one big cluster containing all objects. The result is a tree-based representation of the objects, known as a dendrogram. This methodology is used in a broad range of applications. In one embodiment, the present invention uses specific requirements of the data in order to create smart ways of choosing which levels are included and which are excluded.

In one embodiment, AHC designs a hierarchical clustering tree that breaks out clustered items individually or in small groups based on similarity. This means that the normal implementation has as many levels as there are items to cluster. Most uses of AHC focus on the small differences in single items, or rest on an outside choice of the number of clusters to show. The present invention does not show users the small changes in the similarity of specific patents, and the number of clusters to view, as the present invention is programmed to automatically process that data internally.

In one embodiment, the present invention approximates the creation of a technology taxonomy that is unique to the patent portfolio being clustered. The present invention uses a novel methodology for skipping and/or selecting which distances (equivalent to levels in a clustering tree) to present by approximating the technology taxonomy so that the user is only presented with the most important content.

The patent clustering methodology of the present invention creates clusters that are unique to the dataset utilizing unsupervised machine learning methods, rather than being categorized based on an overarching view of the patent corpus. These clusters are compiled instantly and in real time, and as such are able to dynamically integrate new technologies and embeddings, as opposed to Cooperative Patent Classifications (“CPC”) where new technology can be misclassified until the CPC organizer is able to create a new class for them.

In another embodiment, the output of the AHC algorithm of the present invention is is represented as a tree like structure to which filtering and processing steps are applied with the objective of minimizing noise and surfacing the salient features of a collection of patents. The key is the identifying levels in the tree like structure that can be removed. Without this processing and filtering method, the tree like structure will be too tall. The processed tree is a concise and refined presentation of the data.

The present invention identifies high-information-content clusters. This is done by finding the most meaningful parent-child relationships within a tree like structure.

In one embodiment, each cluster is summarized by a collection of key phrases or by a passage of text generated by our algorithm. In both cases the words that are used to summarize the cluster are based on the texts of the patents in the cluster. Some phrases or passages are more informative than others. The phrases and texts generated by the algorithm of the present invention are edited using various filtering and processing techniques to ensure that the highest-information-content phrases or texts are used to summarize the cluster.

The present invention utilizes a methodology for creating hierarchical groupings of patents that share common characteristics, then selectively eliminating elements of that hierarchy in order to optimize for information gain between levels. Once those groupings have been chosen, they are formed into a new hierarchy and the contents of each group are summarized. This results in a taxonomy that facilitates the exploration and retrieval of patents. The normal output of AHC is not sufficient for patent clustering as it shows far more granular changes in groupings.

The present invention can “skip” levels, landing only on those that show a meaningful change in and display of a technology taxonomy. For example, in a group of video patents, it will not necessarily immediately break them into streaming vs. UI patents. It is more likely the case that it will progressively single out the “most different” patent(s). Eventually it will continue breaking out patents such that these groups are formed. The objective of the present invention is to skip levels until that point. Users do not want to start with “video patents” and drill down to see the clusters “Video Patents” and “The single video patent that is most different from the rest”. That information and change is not useful until the video patents group has been sufficiently broken up as to show distinct sub-technology groupings. Eventually it will form these groups, but these levels have to be “skipped” until these cohesive groups are formed.

The present invention uses AHC to build levels in reverse by starting with single patents and progressively grouping them based on similarity. The starting level may be chosen based on an arbitrary number of starting clusters or may explore an optimization problem of choosing starting level based on minimized average cosine similarity of patents within the distinct clusters, among other methods.

The present invention continues skipping levels until determined threshold of minimum increase in number of clusters as compared to previously chosen level (“Parent Level”). This minimum increase in the number of clusters as compared to a previously chosen level can either use a multiplier (i.e. 2× as many), or that minimum increase multiplier may change (increase or decrease) as a function of tree depth (i.e., as the exploration into clusters gets more specific, it may not require as many technology breakdowns across a tree when at a new level).

In one embodiment, the present invention counts the added clusters from level to level, excluding singletons (or other minimum cluster size thresholding). In counting the new clusters as compared to a previously chosen level, it may be desired to exclude any “child” clusters with a minimum number of patents from that count (i.e. exclude clusters with only one patent from the count of new clusters). The minimum cluster size may change as a function of depth within the tree. It may not necessarily be a single number (i.e. one patent in a cluster), but may also incorporate the count of how many new small clusters there are (i.e., counting single patent clusters in the next level if there are ten new ones. The Largest cluster(s) must change from previous level. However, it is possible that enough sufficiently large clusters have been found in the child level as to choose to display it, but if the largest cluster(s) from the parent level has not changed then the new level won't provide enough information to be useful. So, the present invention continues to skip.

Variables of this function may include looking at the number of parent clusters that have/have not changed and determining how many/which have to change as a function of size and ratio of number of clusters and/or the portfolio size overall. This threshold may change as a function of size of previous cluster (i.e., relatively large changes to the larger clusters (if “video” is a large, high level category with lots of patents, the next breaks should form relatively large sub-groups). That function may further change as a function of depth (i.e., larger changes at the higher levels of the tree).

In another embodiment, the present invention forms a new linkage matrix, which is part of the process of display. AHC requires forming a matrix that links the levels. Since the present invention may skip levels, unused levels have to be discarded in order to reform the matrix. The present invention incorporates a Display of Key Phrases and Symmetric Difference of Phrases Rule. Once the clusters at each level are determined, these phrases are then extracted from each patent within the cluster, grouped and displayed by which phrases describe the grouping most fully. Since the clustering is hierarchical, a parent and child cluster may have share many of the most descriptive phrases. As there are a lot of repeated terms within a portfolio (even in different technologies) Different clusters within the same level may share phrases. The present invention does not allow for shared phrases between parent and child clusters, or shared phrases between sibling clusters (within a level).

### BRIEF DESCRIPTION OF THE DRAWINGS

FIG. 1 is a diagram of agglomerative clustering.

FIG. 2 is a diagram of a cluster dendrogram.

FIG. 3 is a diagram showing the level skipping process of the present invention.

FIG. 4 is a diagram of headline key phrase determination of the present invention.

FIG. 5 is an illustration depicting an exemplary operating environment including one or more user computers, computing devices, or processing devices, which can be used to operate a client on a dedicated application such as web browser is shown.

FIG. 6 is another illustration depicting an exemplary operating environment including a computer system with various elements as shown.

### DETAILED DESCRIPTION OF THE PREFERRED EMBODIMENT

Hierarchical clustering is a cluster analysis method, which produce a tree-based representation (e.g., dendrogram) of a data. Objects in the dendrogram are linked together based on their similarity.

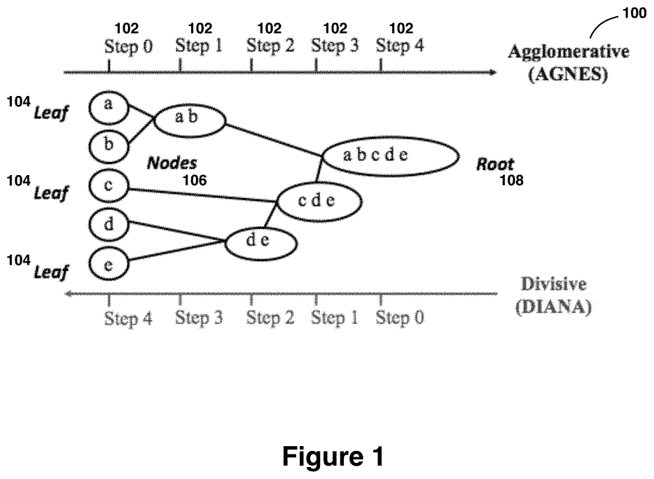

FIG. 1 is a diagram of agglomerative clustering. In accordance with the preferred embodiment of the present invention, agglomerative clustering 100 works in a “bottom-up” manner. That is, each object is initially considered as a single-element cluster (leaf) 104. At each step of the algorithm 102, the two clusters that are the most similar are combined into a new bigger cluster (nodes) 106. This procedure is iterated until all points are member of just one single big cluster (root) 108. The process of agglomerative hierarchical clustering is achieved by: preparing the data; computing (dis)similarity information between every pair of objects in the data set; using linkage function to group objects into hierarchical cluster tree, based on the generated distance information; and determining where to cut the hierarchical tree into clusters. This creates a partition of the data. Data structure and preparation of agglomerative hierarchical clustering involves plotting the data on a numeric matrix, with the rows representing observations (or individuals), and columns representing variables.

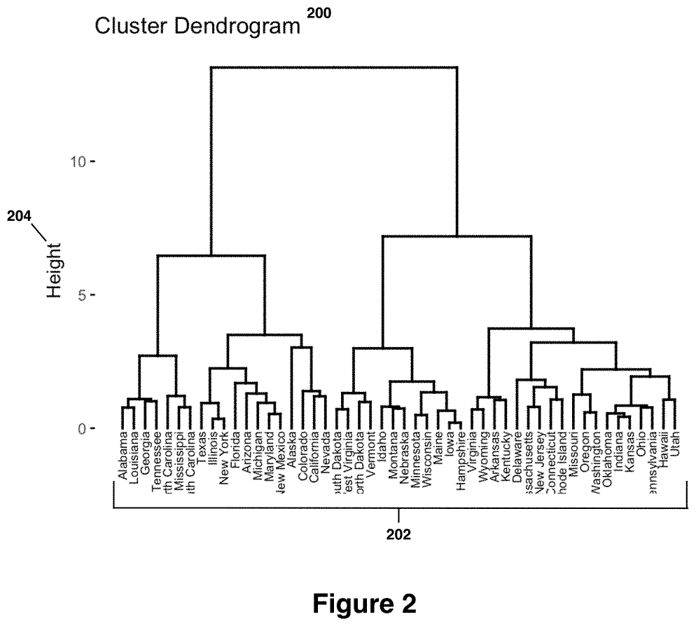

FIG. 2 is a diagram of a cluster dendrogram. In accordance with the preferred embodiment of the present invention, a cluster dendrogram 200 corresponds to the graphical representation of the hierarchical tree. As shown in FIG. 2, each leaf of the cluster dendrogram 200 corresponds to one object. As we move up the tree, objects 202 that are similar to each other are combined into branches, which are themselves fused at a higher height 204. The height of the fusion 204, provided on the vertical axis, indicates the (dis)similarity or distance between two objects or clusters. The higher the height of the fusion 204, the less similar the objects are.

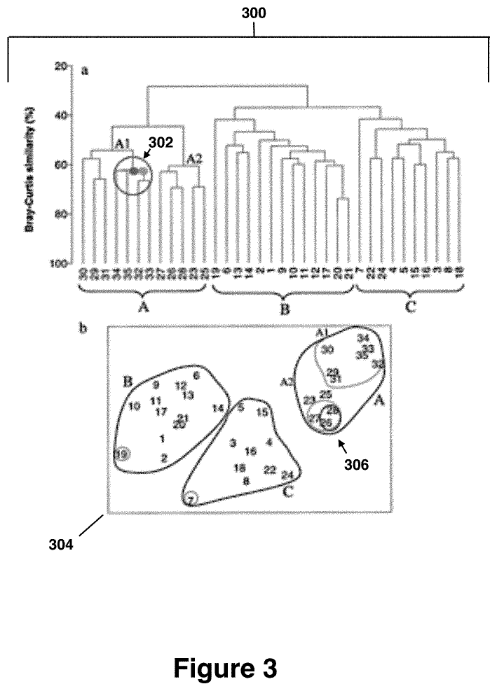

FIG. 3 is a diagram showing the level skipping process of the present invention. In accordance with the preferred embodiment, the present invention uses a novel methodology for skipping and/or selecting which levels 300 to present in order to approximate a technology taxonomy so that the user is only presented with the most important content. The Al cluster circle 302 shows a change of level 300 as the portfolio continues to be broken up. Note that the dots inside the Al cluster circle 302 coordinate with the circles at the bottom of the dendrogram 304. This change in level shows that the difference in the cluster between levels was 1 patent of 3 breaking off 306. This is not sufficient for patent clustering, as the single breakoff is unlikely to be of valuable information for the user.

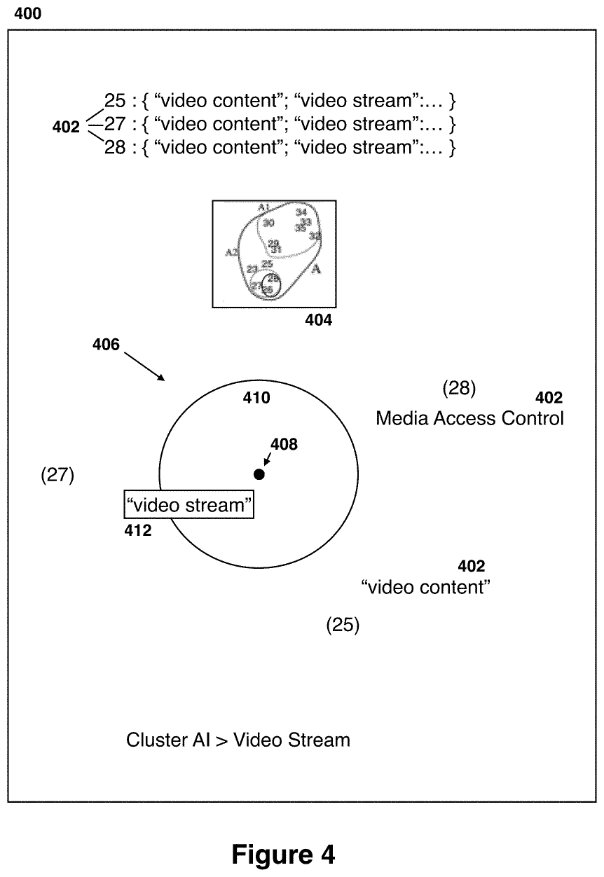

FIG. 4 is a diagram of headline key phrase determination of the present invention. In accordance with the preferred embodiment of the present invention, each cluster is summarized by a collection of key phrases or by a passage of text generated by our algorithm, extractive and abstractive summarization respectively. In both cases the words that are used to summarize the cluster are based on the texts of the patents in the cluster. Some phrases or passages are more informative than others. The phrases and texts generated by the algorithm of the present invention are edited using various filtering and processing techniques to ensure that the highest-information-content phrases or texts are used to summarize the cluster. FIG. 4 is a simplified presentation 400 as to how clusters are summarized using phrases within the cluster. The set of key phrases 402 derived from each patent in a cluster is shown at the top of the figure. In this example, the plotted diagram 404 and the circle (ring) diagram 406 below the key phrases 402 show how these key phrases 402 are mapped in a similar way to how the present invention maps patents overall. In general, the patents and their phrases are represented by their respective finite dimensional vectors which are elements of a finite-dimensional inner product space. The centroid 408 is a point in this space and a ball of radius R 410 is formed. Key phrases 402 whose distance to the centroid 408 is less than R 410 are kept 412.

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Persons of ordinary skill in the art are able to understand that all or portions of the steps in the embodiments described above may be realized using programs instructing the relevant hardware, and said programs can be stored on computer-readable storage media, such as a read-only memory, hard disk or compact disc. Optionally, all or portions of the steps of the embodiments described above may also be realized using one or multiple integrated circuits. Accordingly, the various modules/units contained in the embodiments above may also be realized in the form of hardware or software function modules. Thus, the present application is not limited to any specific combination of hardware and software.

The present application may have a variety of other embodiments and, without departing from the spirit and substance of the present application, persons skilled in the art may produce a variety of corresponding changes and modifications based on the present application, but these corresponding changes and modifications shall all fall within the scope of protection of the claims of this application.

Although the foregoing embodiments have been described in some detail for purposes of clarity of understanding, the invention is not limited to the details provided. There are many alternative ways of implementing the invention. The disclosed embodiments are illustrative and not restrictive.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

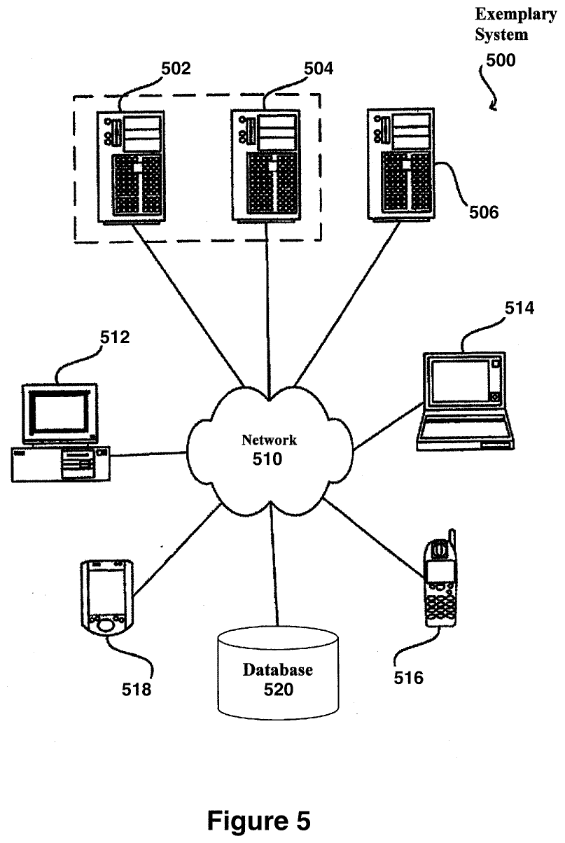

FIG. 5 is a block diagram illustrating components of an exemplary operating environment in which embodiments of the present invention may be implemented. The system 500 can include one or more user computers, computing devices, or processing devices 512, 514, 516, 518, which can be used to operate a client, such as a dedicated application, web browser, etc. The user computers 512, 514, 516, 518 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 512, 514, 516, 518 may also have any of a variety of applications, including one or more development systems, database client and/or server applications, and Web browser applications. Alternatively, the user computers 512, 514, 516, 518 may be any other electronic device, such as a thin-client computer, Internet-enabled gaming system, and/or personal messaging device, capable of communicating via a network (e.g., the network 510 described below) and/or displaying and navigating Web pages or other types of electronic documents. Although the exemplary system 500 is shown with four user computers, any number of user computers may be supported.

In most embodiments, the system 500 includes some type of network 510. The network can be any type of network familiar to those skilled in the art that can support data communications using any of a variety of commercially-available protocols, including without limitation TCP/IP, SNA, IPX, AppleTalk, and the like. Merely by way of example, the network 510 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 502, 504, 506 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 506) may be dedicated to running applications, such as a business application, a Web server, application server, etc. Such servers may be used to process requests from user computers 512, 514, 516, 518. The applications can also include any number of applications for controlling access to resources of the servers 502, 504, 506.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 512, 514, 516, 518. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM®. and the like, which can process requests from database clients running on a user computer 512, 514, 516, 518.

The system 500 may also include one or more databases 520. The database(s) 520 may reside in a variety of locations. By way of example, a database 520 may reside on a storage medium local to (and/or resident in) one or more of the computers 502, 504, 506, 512, 514, 516, 518. Alternatively, it may be remote from any or all of the computers 502, 504, 506, 512, 514, 516, 518, and/or in communication (e.g., via the network 510) with one or more of these. In a particular set of embodiments, the database 520 may reside in a storage-area network (“SAN”) familiar to those skilled in the art. Similarly, any necessary files for performing the functions attributed to the computers 502, 504, 506, 512, 514, 516, 518 may be stored locally on the respective computer and/or remotely, as appropriate. In one set of embodiments, the database 520 may be a relational database, such as Oracle 10g that is adapted to store, update, and retrieve data in response to SQL-formatted commands.

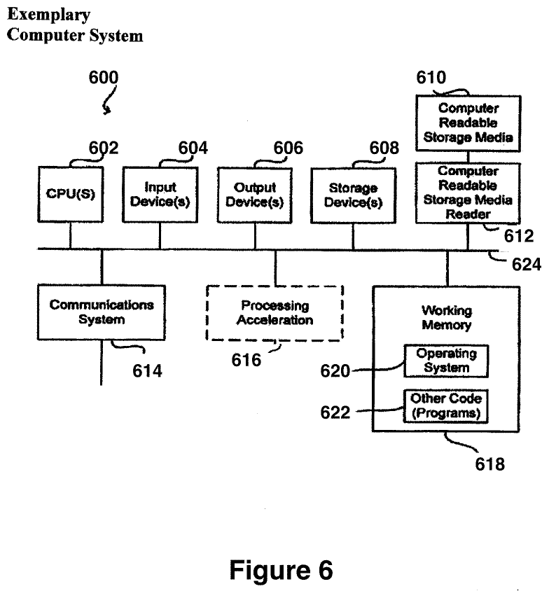

FIG. 6 illustrates an exemplary computer system 600, in which embodiments of the present invention may be implemented. The system 600 may be used to implement any of the computer systems described above. The computer system 600 is shown comprising hardware elements that may be electrically coupled via a bus 624. The hardware elements may include one or more central processing units (CPUs) 602, one or more input devices 604 (e.g., a mouse, a keyboard, etc.), and one or more output devices 606 (e.g., a display device, a printer, etc.). The computer system 600 may also include one or more storage devices 608. By way of example, the storage device(s) 608 can include devices such as disk drives, optical storage devices, solid-state storage device such as a random access memory (“RAM”) and/or a read-only memory (“ROM”), which can be programmable, flash-updateable and/or the like.

The computer system 600 may additionally include a computer-readable storage media reader 612, a communications system 614 (e.g., a modem, a network card (wireless or wired), an infra-red communication device, etc.), and working memory 618, which may include RAM and ROM devices as described above. In some embodiments, the computer system 600 may also include a processing acceleration unit 616, which can include a digital signal processor DSP, a special-purpose processor, and/or the like.

The computer-readable storage media reader 612 can further be connected to a computer-readable storage medium 610, together (and, optionally, in combination with storage device(s) 608) comprehensively representing remote, local, fixed, and/or removable storage devices plus storage media for temporarily and/or more permanently containing, storing, transmitting, and retrieving computer-readable information. The communications system 614 may permit data to be exchanged with the network and/or any other computer described above with respect to the system 600.

The computer system 600 may also comprise software elements, shown as being currently located within a working memory 618, including an operating system 620 and/or other code 622, such as an application program (which may be a client application, Web browser, mid-tier application, RDBMS, etc.). It should be appreciated that alternate embodiments of a computer system 600 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 6 further illustrates an environment where an on-demand distributed database service might be used. As illustrated in FIG. 6, user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium®. processor or the like. Similarly, a computer system (and additional instances of an enterprise database, where more than one is present) and all of their components might be operator configurable using application(s) including computer code run using a central processing unit such as an Intel Pentium®. processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java™, JavaScript, ActiveX, any other scripting language such as VBScript, and many other programming languages as are well known. (Java™. is a trademark of Sun Microsystems, Inc.).

The above illustrations provide many different embodiments for implementing different features of the invention. Specific embodiments of components and processes are described to help clarify the invention. These are, of course, merely embodiments and are not intended to limit the invention from that described in the claims.

Persons of ordinary skill in the art will realize that the foregoing description is illustrative only and not in any way limiting. Other modifications and improvements will readily suggest themselves to such skilled persons having the benefit of this disclosure.

While embodiments and applications of this disclosure have been shown and described, it would be apparent to those skilled in the art that many more modifications and improvements than mentioned above are possible without departing from the inventive concepts herein. The disclosure, therefore, is not to be restricted except in the spirit of the appended claims.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removable or remotely coupled to an information processing system. The computer readable media may include, for example and without limitation, any number of the following: magnetic storage media including disk and tape storage media; optical storage media such as compact disk media (e.g., CD ROM, CD R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

The present technology requires a data processing system with sufficient memory and processing power to store and recall user data in real time. In addition, the invention may be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups. In particular, the distributed decentralized network discussed herein must be capable of analyzing user and bid data in a manner that can optimize the bidding process.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” and/or “consisting essentially of.”

What is claimed is:

1. A machine learning enabled platform system, comprising:
A machine learning model stored in memory, the machine learning model trained on a plurality of patents owned by patent owners, the plurality of patents containing inventions;
A processing device operatively coupled to memory comprising instructions, wherein the processing device is configured to:
Receive an input from a partner, the input including an identity of the partner and associated with an invention described in a patent upon which the machine learning model is trained;
Query the machine learning model to output an identity of at least one patent owner associated with the invention and the patent associated with the patent owner;
Receive a notification from the patent owner associated with the invention indicating a willingness to transact the patent;
Register a match between the partner and the patent owner based on an identity of the partner and an identity of the patent owner;
Initiate a real-world discussion between the patent owner and the partner regarding the invention described in the patent; and
Mediate the real-world discussion by providing a secure channel of communication between the patent owner and the partner within the platform using an agglomerative hierarchical clustering method for patent clustering based on patent similarity.

2. A system according to claim 1 wherein said agglomerative clustering starts by treating each object as a singleton cluster.

3. A system according to claim 1 wherein said agglomerative clustering merges pairs of clusters are successively until all clusters have been merged into one big cluster containing all objects, resulting in a tree-based representation of the objects known as a dendrogram.

4. A method of machine learning, comprising:
A machine learning model stored in memory, the machine learning model trained on a plurality of patents owned by patent owners, the plurality of patents containing inventions;
A processing device operatively coupled to memory comprising instructions, wherein the processing device is configured to:
Receive an input from a partner, the input including an identity of the partner and associated with an invention described in a patent upon which the machine learning model is trained;
Query the machine learning model to output an identity of at least one patent owner associated with the invention and the patent associated with the patent owner;
Receive a notification from the patent owner associated with the invention indicating a willingness to transact the patent;
Register a match between the partner and the patent owner based on an identity of the partner and an identity of the patent owner;
Initiate a real-world discussion between the patent owner and the partner regarding the invention described in the patent; and
Mediate the real-world discussion by providing a secure channel of communication between the patent owner and the partner within the platform using an agglomerative hierarchical clustering method for patent clustering based on patent similarity.

5. A method according to claim 4 wherein said agglomerative clustering starts by treating each object as a singleton cluster.

6. A method according to claim 4 wherein said agglomerative clustering merges pairs of clusters are successively until all clusters have been merged into one big cluster containing all objects, resulting in a tree-based representation of the objects known as a dendrogram.
